(19) United States
(12) Patent Application Publication
(10) Pub. No.: US 2020/0164802 A1
(43) Pub. Date: May 28, 2020

(54) VEHICLE CONTROL APPARATUS, CONTROL METHOD, AND STORAGE MEDIUM FOR STORING PROGRAM

(71) Applicant: HONDA MOTOR CO., LTD., Tokyo (JP)

(72) Inventor: Kenta TAKENAKA, Wako-shi (JP)

(21) Appl. No.: 16/663,510

(22) Filed: Oct. 25, 2019

(30) Foreign Application Priority Data
Nov. 26, 2018 (JP) 2018-220580

(51) Int. Cl. B60R 1/00; B60R 11/04; H04N 5/57

(52) U.S. Cl. CPC B60R 1/002; B60R 2300/70; H04N 5/57; B60R 11/04

(57) ABSTRACT

A vehicle control apparatus comprises a shooting unit configured to shoot a periphery of a vehicle, a display unit configured to display an image shot by the shooting unit, an acquisition unit configured to acquire illuminance information regarding peripheral illuminance of the vehicle, and a control unit configured to control a display mode of the display unit based on the illuminance information acquired by the acquisition unit. At a predetermined timing pertaining to reception of an instruction relating to traveling of the vehicle, the acquisition unit starts acquiring the illuminance information, when the display unit starts displaying the image.

### CROSS-REFERENCE TO RELATED APPLICATION(S)

This application claims priority to and the benefit of Japanese Patent Application No. 2018-220580 filed on Nov. 26, 2018, the entire disclosure of which is incorporated herein by reference.

### BACKGROUND OF THE INVENTION

### Field of the Invention

The present invention relates to a vehicle control apparatus including a peripheral monitoring system, a control method, and a storage medium for storing a program.

### Description of the Related Art

A configuration in which door mirrors are not provided, and cameras that capture images side-rearward of a vehicle, and displays that display images shot by the cameras are used in place of existing side mirrors are becoming wide-spread. Japanese Patent Laid-Open No. 2017-201773 describes a technique in which the change from an off state to an on state of the ignition of a vehicle is determined, and turning on or off of a camera system is controlled based on the determination. Also, Japanese Patent Laid-Open No. 2018-046424 describes a technique in which, when the engine is stopped and a door is open, if it is detected that a driver is seated, display means is operated normally, and if it is detected that a driver is not seated, the display means is caused to enter a standby state. Also, Japanese Patent Laid-Open No. 2018-142760 describes a technique in which an image for boarding is displayed in a display apparatus in a period from a door of the vehicle is opened until the ignition is turned on.

However, a technique in which an image obtained by shooting side-rearward of a vehicle is displayed in accordance with peripheral illuminance of the vehicle in a state in which the ignition is turned off is not described in any of the patent documents.

### SUMMARY OF THE INVENTION

The present invention provides a vehicle control apparatus that, at a predetermined timing, starts to acquire information regarding peripheral illuminance of a vehicle when starting the display of shot images, and displays shot images in accordance with the peripheral illuminance of the vehicle, a control method, and a storage medium for storing a program.

The present invention in its first aspect provides a vehicle control apparatus including: a shooting unit configured to shoot a periphery of a vehicle; a display unit configured to display an image shot by the shooting unit; an acquisition unit configured to acquire illuminance information regarding peripheral illuminance of the vehicle; and a control unit configured to control a display mode of the display unit based on the illuminance information acquired by the acquisition unit. At a predetermined timing pertaining to reception of an instruction relating to traveling of the vehicle, the acquisition unit starts acquiring the illuminance information, when the display unit starts displaying the image.

The present invention in its second aspect provides a control method to be executed in a vehicle control apparatus, the control method including: displaying an image shot by a shooting unit that shoots a periphery of a vehicle; acquiring illuminance information regarding peripheral illuminance of the vehicle; controlling a display mode of the display unit based on the acquired illuminance information; and, at a predetermined timing pertaining to reception of an instruction relating to traveling of the vehicle, starting acquiring the illuminance information, when the display unit starts displaying the image.

The present invention in its third aspect provides a non-transitory computer-readable storage medium storing a program causing a computer to: display an image shot by a shooting unit that shoots a periphery of a vehicle; acquire illuminance information regarding peripheral illuminance of the vehicle; control a display mode of the display unit based on the acquired illuminance information; and, at a predetermined timing pertaining to reception of an instruction relating to traveling of the vehicle, start acquiring the illuminance information, when the display unit starts displaying the image.

According to the present invention, at a predetermined timing, acquisition of information regarding peripheral illuminance of the vehicle is started when the display of shot images is started, and the display of the shot images in accordance with the peripheral illuminance of the vehicle can be performed.

### BRIEF DESCRIPTION OF THE DRAWINGS

FIG. 1 is a diagram illustrating a configuration of a vehicle control apparatus.

FIG. 2 is a diagram illustrating functional blocks of a control unit.

FIG. 3 is a diagram illustrating a connection configuration between a controller and a CMS and an automated lighting system.

FIG. 4 is a diagram illustrating installation positions of cameras, displays, and illuminance sensors.

FIG. 5 is a flowchart illustrating processing for controlling the brightness of a CMS display.

FIG. 6 is a flowchart illustrating processing for controlling the brightness.

FIG. 7 is a flowchart illustrating processing for controlling the brightness of the CMS display.

FIG. 8 is a diagram illustrating the correspondence relation between peripheral illuminance and brightness.

FIG. 9 is a flowchart illustrating processing for controlling the brightness of the CMS display.

FIG. 10 is a flowchart illustrating processing for retaining a brightness step value.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Two or more aspects of the plurality of aspects described in the embodiments may be arbitrarily combined. The same or similar constituent elements are given the same reference numerals, and a description thereof is omitted.

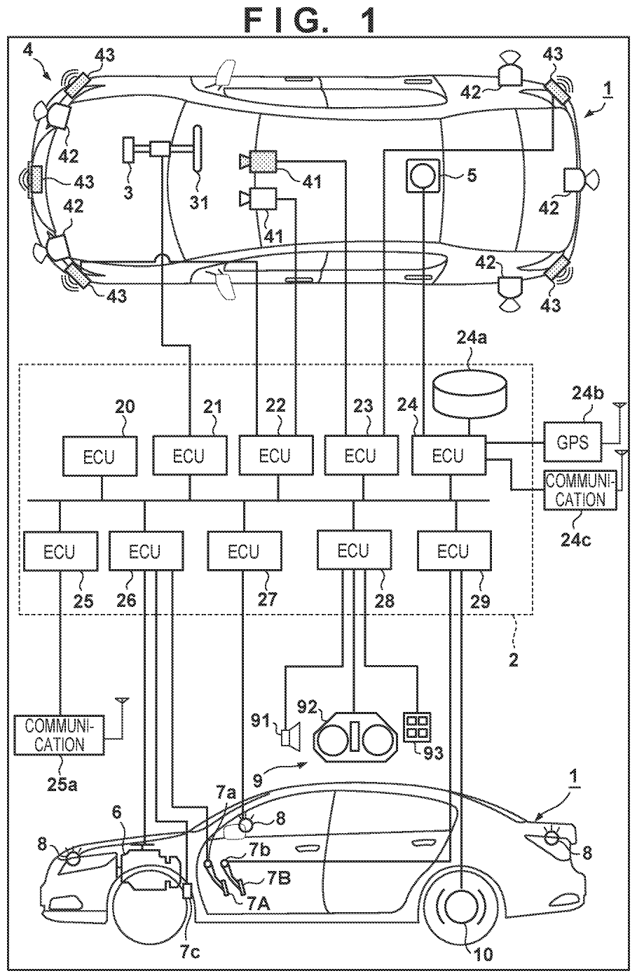

FIG. 1 is a block diagram of a vehicle control apparatus that controls a vehicle 1 according to one embodiment of the present invention. In FIG. 1, the outline of the vehicle 1 is shown as a plan view and a side view. The vehicle 1 is a sedan type four-wheel passenger car, for example.

The control apparatus in FIG. 1 includes a control unit 2. The control unit 2 includes a plurality of ECUs 20 to 29 that are communicably connected through an in-vehicle network. Each ECU includes a processor represented by a CPU, a storage device such as a semiconductor memory, and an interface for an external device. The storage device stores programs to be executed by the processor, data that the processor uses in processing, and the like. Each ECU may include a plurality of processors, storage devices, and interfaces. Also, the configuration of the control apparatus in FIG. 1 may be realized by a computer that executes the method of the present invention according to a program.

Hereinafter, functions and the like of the ECUs 20 to 29 will be described. Note that the number and functions of the ECUs can be appropriately designed, and more ECUs can be used or some EUCs can be integrated.

The ECU 20 executes control relating to autonomous driving of the vehicle 1. In the autonomous driving, at least one of steering and acceleration/deceleration of the vehicle 1 is automatically controlled. In later-described exemplary control, both of steering and acceleration/deceleration are automatically controlled.

The ECU 21 controls an electric power steering apparatus 3. The electric power steering apparatus 3 includes a mechanism for steering the front wheels in accordance with the driving operation (steering operation) of a driver made on a steering wheel 31. Also, the electric power steering apparatus 3 includes a motor that exerts a driving force for assisting the steering operation or automatically steering the front wheels, a sensor for detecting the steering angle, and the like. When the driving state of the vehicle 1 is autonomous driving, the ECU 21 controls the running direction of the vehicle 1 by automatically controlling the electric power steering apparatus 3 in accordance with the instruction from the ECU 20.

The ECUs 22 and 23 control detection units 41 to 43 that detect conditions around the vehicle, and perform information processing on the detection results. The detection units 41 (hereinafter, may also be denoted as cameras 41) are cameras that captures an image forward of the vehicle 1, and is installed at a roof front part and on an interior side of the front window, in the present embodiment. The contour of an object and lane markings (such as white lines) on a road can be extracted by analyzing images captured by the cameras 41.

Detection units 42 are LIDARs (Light Detection and Ranging), and detect an object around the vehicle 1, and measure the distance to the object. In the case of the present embodiment, five detection units 42 are provided, namely one each at front corners of the vehicle 1, one at the rear center, and one each at rear side faces thereof. Detection units 43 (hereinafter, may also be denoted as radars 43) are millimeter wave radars, and detect an object around the vehicle 1, and measure the distance to the object. In the case of the present embodiment, five radars 43 are provided, namely one at the front center of the vehicle 1, one each at the front corners, and one each at rear corners.

The ECU 22 controls one of the cameras 41 and the detection units 42, and performs information processing on detection results. The ECU 23 controls the other camera 41 and the radars 43, and performs information processing on detection results. As a result of including two sets of apparatuses for detecting conditions around the vehicle, the reliability of the detection result can be improved, and as a result of including different types of detection units such as cameras and radars, the surrounding environment of the vehicle can be analyzed in a multifaceted manner.

The ECU 24 controls a gyrosensor 5, a GPS sensor 24b, and a communication apparatus 24c, and performs information processing on detection results and communication results. The gyrosensor 5 detects the rotational motion of the vehicle 1. The course of the vehicle 1 can be determined based on the detection result of the gyrosensor 5, wheel speed, and the like. The GPS sensor 24b detects the current position of the vehicle 1. The communication apparatus 24c performs wireless communication with a server that provides map information, traffic information, and weather information, and acquires these pieces of information. The ECU 24 can access a database 24a of the map information constructed in a storage device, and searches the route from the current place to a destination, and the like. Note that the database of the aforementioned traffic information and weather information may be constructed in the database 24a.

The ECU 25 includes a communication apparatus 25a for inter-vehicle communication. The communication apparatus 25a performs wireless communication with other vehicles around the vehicle 1, and exchanges information between vehicles.

The ECU 26 controls a power plant 6. The power plant 6 is a mechanism that outputs a driving force for rotating driving wheels of the vehicle 1, and includes an engine and a transmission, for example. The ECU 26 controls the engine output in response to a driving operation (accelerator pedal operation or acceleration operation) made by the driver that has been detected by an operation detection sensor 7a provided in an accelerator pedal 7A, and switches the shift stage of the transmission based on information such as vehicle speed detected by a vehicle speed sensor 7c, for example. When the driving state of the vehicle 1 is the autonomous driving, the ECU 26 automatically controls the power plant 6, and controls acceleration and deceleration of the vehicle 1, in response to the instruction from the ECU 20.

The ECU 27 controls lighting devices (such as headlight and taillight) including direction indicators 8 (winkers). In the case of the example in FIG. 1, the direction indicators 8 are provided at the front and rear of the vehicle 1 and at door mirrors.

The ECU 28 controls an input/output apparatus 9. The input/output apparatus 9 outputs information to the driver, and receives information from the driver. An audio output apparatus 91 notifies the driver of information by sound. The display apparatus 92 notifies the driver of information by displaying an image. The display apparatus 92 is arranged in front of a driving seat, for example, and constitutes an instrument panel or the like. Note that sound and display are illustrated here, but the driver may be notified of information using vibration or light. Also, the driver may be notified of information by combining two or more of sound, display, vibration, and light. Moreover, the combination or the reporting mode may be changed in accordance with the level of information (degree of urgency, for example) to be notified of Also, the display apparatus 92 includes a navigation apparatus.

An input apparatus 93 is arranged at a position at which the driver can operate it, and is a switch group for giving instructions to the vehicle 1. The input apparatus 93 may include a voice input apparatus.

The ECU 29 controls braking apparatuses 10 and a parking brake (not illustrated). The braking apparatuses 10 are disc brake apparatuses, for example, and provided at respective wheels of the vehicle 1 in order to decelerate or stop the vehicle 1 by applying resistance to the rotation of the wheels. The ECU 29 controls the operation of the braking apparatuses 10 in response to the driving operation (brake operation) made by the driver that is detected by an operation detection sensor 7b provided at a brake pedal 7B, for example. When the driving state of the vehicle 1 is autonomous driving, the ECU 29 controls deceleration or stopping of the vehicle 1 by automatically controlling the braking apparatuses 10 in response to the instruction from the ECU 20. The braking apparatuses 10 and the parking brake can be operated to keep the vehicle 1 at a stopped state. Also, if the transmission of the power plant 6 includes a parking lock mechanism, this mechanism can be operated to keep the vehicle 1 at a stopped state.

Exemplary Control

The control relating to the autonomous driving of the vehicle 1 to be executed by the ECU 20 will be described. Upon being instructed the destination and the autonomous driving by the driver, the ECU 20 automatically controls the traveling of the vehicle 1 toward the destination in accordance with the guide route retrieved by the ECU 24. When automatic control is performed, the ECU 20 acquires information (outside information) regarding the conditions around the vehicle 1 from the ECUs 22 and 23, and controls steering and acceleration and deceleration of the vehicle 1 by instructing the ECUs 21, 26, and 29 based on the acquired information.

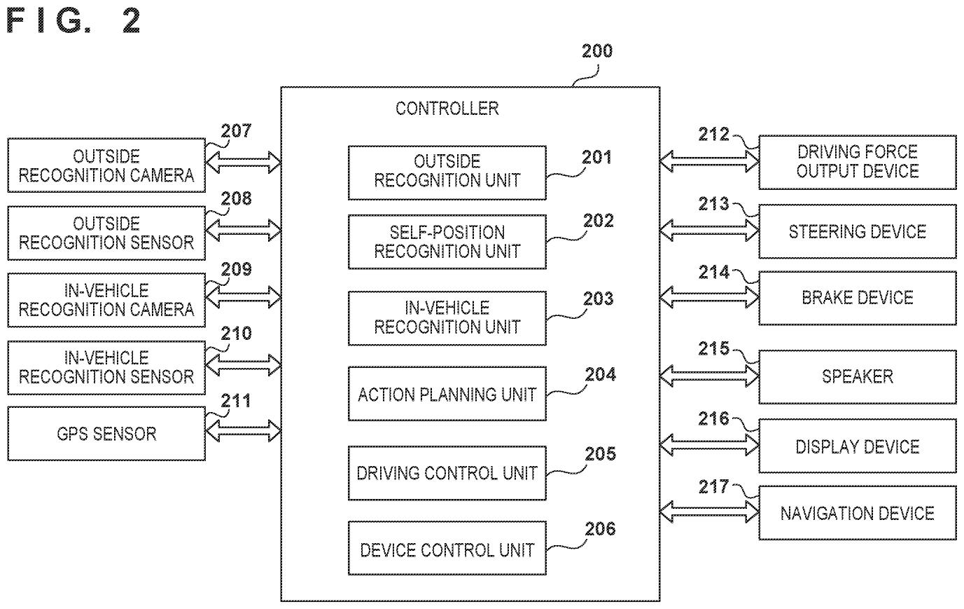

FIG. 2 is a diagram illustrating the functional blocks of the control unit 2. A controller 200 corresponds to the control unit 2 in FIG. 1, and includes an outside recognition part 201, a self-position recognition part 202, an interior recognition part 203, an action planning part 204, a driving controller 205, and a device controller 206. Each block can be realized by one ECU or a plurality of ECUs shown in FIG. 1.

The outside recognition part 201 recognizes the outside information of the vehicle 1 based on signals from outside recognition cameras 207 and outside recognition sensors 208. Here, the outside recognition cameras 207 are the cameras 41 in FIG. 1, for example, and the outside recognition sensors 208 are constituted by the detection units 42 and 43 in FIG. 1, for example. The outside recognition part 201 recognizes the scene such as an intersection, a railroad crossing, and a tunnel, a free space such as a road shoulder, and behaviors (speeds and running directions) of other vehicles, for example, based on signals from the outside recognition cameras 207 and the outside recognition sensors 208. The self-position recognition part 202 recognizes the current position of the vehicle 1 based on the signal from the GPS sensor 211. Here, the GPS sensor 211 corresponds to the GPS sensor 24b in FIG. 1, for example.

The interior recognition part 203 identifies a passenger in the vehicle 1, and also recognizes the state of the passenger, based on signals from an interior recognition camera 209 and an interior recognition sensor 210. The interior recognition camera 209 is a near infrared camera installed on the display apparatus 92 in the interior of the vehicle 1, for example, and detects the line of sight direction of the passenger, for example. Also, the interior recognition sensor 210 is a sensor that detects a biological signal of the passenger, for example. The interior recognition part 203 recognizes the state of the passenger such as a dozing state or a working state other than driving based on these signals.

The action planning part 204 plans the action of the vehicle 1 such as an optimum route or a risk aversion route based on the results of recognition by the outside recognition part 201 and the self-position recognition part 202. The action planning part 204 performs entering determination based on a start point and an end point of an intersection, a railroad crossing, or the like, and action planning based on behavior prediction of other vehicles, for example. The driving controller 205 controls a driving force output device 212, a steering device 213, and a braking device 214 based on the action plan made by the action planning part 204. Here, the driving force output device 212 corresponds to the power plant 6 in FIG. 1, the steering device 213 corresponds to the electric power steering apparatus 3 in FIG. 1, and the braking device 214 corresponds to the braking apparatus 10, for example.

The device controller 206 controls devices that are connected to the controller 200. For example, the device controller 206 controls a speaker 215, and causes the speaker 215 to output a predetermined voice message such as a warning or a message for navigation. Also, the device controller 206 controls a display device 216, and causes the display device 216 to display a predetermined interface, for example. The display device 216 corresponds to the display apparatus 92, for example. Also, the device controller 206 controls the navigation device 217, and acquires information set in the navigation device 217, for example.

The controller 200 may appropriately include functional blocks other than those shown in FIG. 2, and may include an optimum route calculation part that calculates an optimum route to the destination based on map information acquired via the communication apparatus 24c, for example. Also, the controller 200 may acquire information from devices other than the cameras and sensors shown in FIG. 2, and may acquire information regarding another vehicle via the communication apparatus 25a, for example. Also, the controller 200 receives detection signals from various sensors provided in the vehicle 1 in addition to the GPS sensor 211. For example, the controller 200 receives detection signals of door open/close sensors and doorlock mechanism sensors that are provided at doors of the vehicle 1 via ECUs installed at the doors. With this, the controller 200 can detect canceling of the doorlocks and opening/closing operations of the doors.

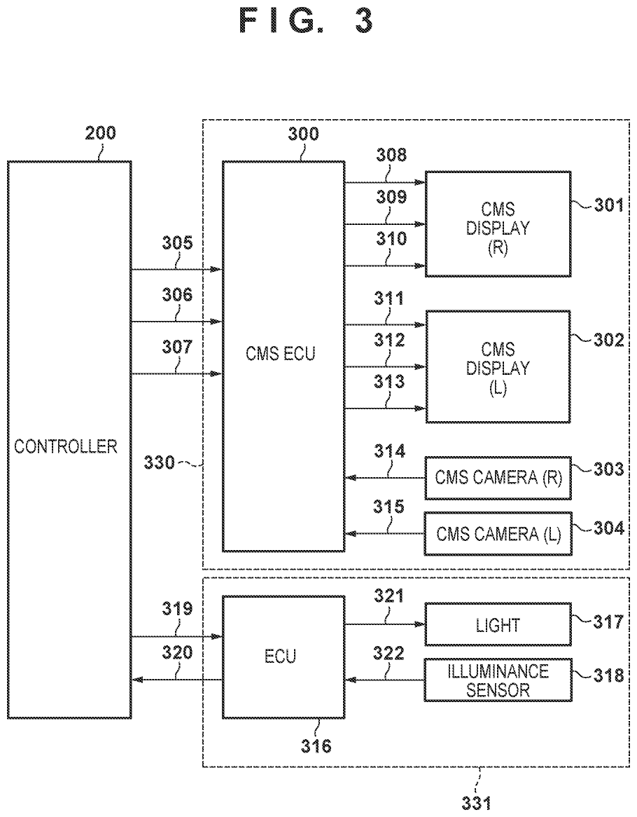

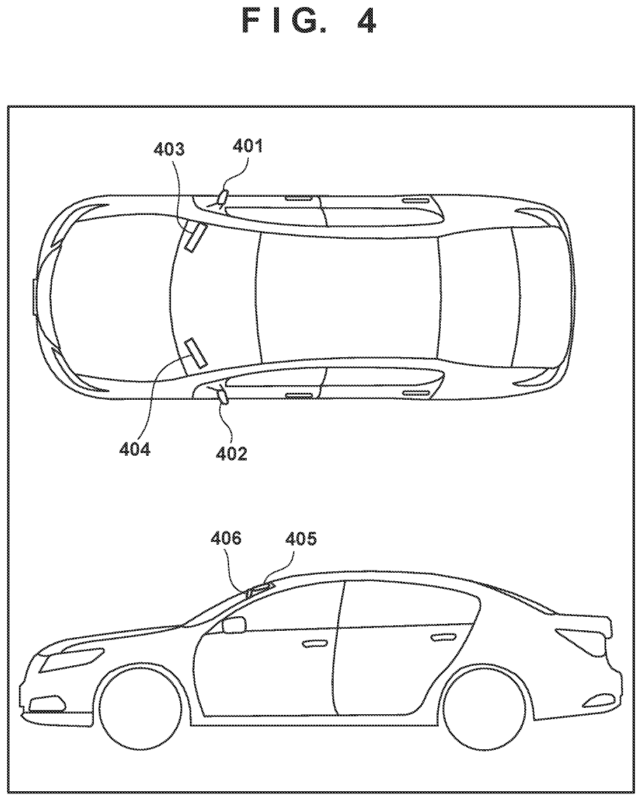

Also, a camera monitoring system (CMS, peripheral monitoring system) and an automated lighting system are connected to the controller 200. FIG. 3 is a diagram illustrating the connection configuration between the controller 200 and a CMS 330 and automated lighting system 331. In the present embodiment, the vehicle 1 is a so-called door mirror-less vehicle in which cameras that capture images rearward of the vehicle 1 is provided in place of the door mirrors. As shown in FIG. 4, cameras 401 and 402 are installed at positions of door mirrors of the vehicle 1. The camera 401 is a camera that captures an image right rearward of the vehicle 1, and the rearward image captured by the camera 401 is displayed in the display 403. Also, the camera 402 is a camera that captures an image left rearward of the vehicle 1, and the rearward image captured by the camera 402 is displayed in the display 404.

The CMS 330 includes a CMS-ECU 300, a CMS display 301, a CMS display 302, a CMS camera 303, and a CMS camera 304. The CMS camera 303 corresponds to the camera 401 in FIG. 4, and the CMS camera 304 corresponds to the camera 402 in FIG. 4. Also, the CMS display 301 corresponds to the display 403 in FIG. 4, and the CMS display 302 corresponds to the display 404 in FIG. 4.

The CMS-ECU 300 integrally control the CMS 330 under the control of the controller 200. The CMS 330 receives a forward illuminance signal 305, an upper illuminance signal 306, and a brightness step value signal 307 from the controller 200. The forward illuminance signal 305 and upper illuminance signal 306 correspond to illuminance signals detected by later-described illuminance sensors 318. The brightness step value signal 307 is a signal for designating the change in brightness of the CMS displays 301 and 302, and will be described later.

In the present embodiment, the CMS displays 301 and 302 changes the brightness of liquid crystal displays thereof in accordance with the peripheral illuminance (brightness) of the vehicle 1. For example, when in a daytime, the brightness of the CMS displays 301 and 302 is increased in accordance with the peripheral illuminance of the vehicle 1. Also, when at twilight or night, the brightness of the CMS displays 301 and 302 is decreased in accordance with the peripheral illuminance of the vehicle 1, for example. The CMS-ECU 300 receives an imaging signal 314 generated by capturing performed by the CMS camera 303 from the CMS camera 303, converts the signal to display rendering data, and transmits the display rendering data to the CMS display 301 as image capturing data 308. Also, the CMS-ECU 300 receives an imaging signal 315 generated by capturing performed by the CMS camera 304 from the CMS camera 304, converts the signal to display rendering data, and transmits the display rendering data to the CMS display 302 as image capturing data 311.

The CMS-ECU 300 transmits the brightness signal 309 to the CMS display 301, and transmits the brightness signal 312 to the CMS display 302. The brightness signals 309 and 312 are associated with the brightness on the correspondence relation between peripheral illuminance and brightness that is determined by the brightness step value signal 307.

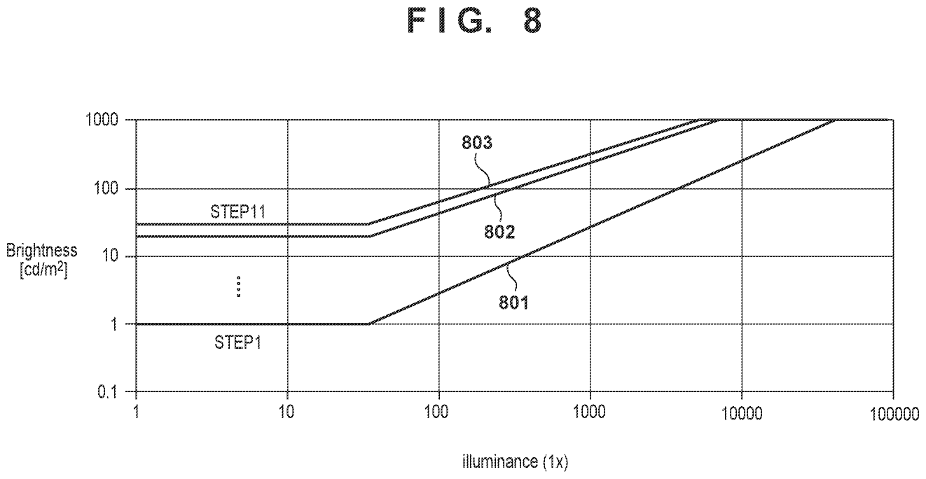

Here, the brightness step value will be described. FIG. 8 is a diagram illustrating the correspondence relation between peripheral illuminance and brightness for defining how the brightness of a display is changed in accordance with the peripheral illuminance of the vehicle 1. For example, the brightness step value 801 (STEP 1) in FIG. 8 defines that the brightness of a display linearly changes in a range from 1 to 1,000 [cd/m²] in accordance with the change of the peripheral illuminance of the vehicle 1 in a range from 30 [1×] to 30,000 [1×]. Also, in the present embodiment, a plurality of types of correspondence relations between peripheral illuminance and brightness are provided in addition to the brightness step value 801, and FIG. 8 shows the brightness step value 801 (STEP 1), a brightness step value 802 (STEP 10), and a brightness step value 803 (STEP 11), out of eleven types of correspondence relations. Also, these plurality of types of correspondence relations are identifiable, and the brightness step values represent pieces of identification information for identifying the respective correspondence relations. The driver sets a desired brightness step value on a setting screen displayed in the display device 216. With such a configuration, the driver can designate a desired change in brightness of the CMS displays 301 and 302 with respect to the peripheral illuminance of the vehicle 1. The correspondence relation in FIG. 8 is retained in the CMS-ECU 300, and upon receiving the brightness step value signal 307, the CMS-ECU 300 adopts the correspondence relation identified by the brightness step value.

The CMS-ECU 300 further transmits gradual change period information 310 to the CMS display 301, and transmits gradual change period information 313 to the CMS display 302. Here, the gradual change period refers to a period for the brightness to change to target brightness in response to the change in peripheral illuminance. The CMS displays 301 and 302 operate as replacements for door mirrors, and therefore the brightness needs to be changed in response to the change in peripheral illuminance. Therefore, the CMS-ECU 300 changes the brightness of the CMS displays 301 and 302 based on the brightness step value and the gradual change period.

The automated lighting system 331 includes an ECU 316, lights 317, and illuminance sensors 318. The lights 317 are a headlight and a taillight, for example. Also, the illuminance sensors 318 are sensors for detecting the peripheral illuminance of the vehicle 1. In the present embodiment, the illuminance sensors 318 include an upper illuminance sensor 405 and a forward illuminance sensor 406. As shown in FIG. 4, the upper illuminance sensor 405 is installed on an interior side of the front window behind a rearview mirror, and detects upper illuminance of the vehicle 1. Also, the forward illuminance sensor 406 is installed on the interior side of the front window behind the rearview mirror, and detects forward illuminance of the vehicle 1. In the present embodiment, rain-light sensors are used as the illuminance sensors 318, for example.

The ECU 316 integrally controls the automated lighting system 331 under the control of the controller 200. When the peripheral illuminance of the vehicle 1 has decreased to a threshold value or less, the automated lighting system 331 automatically turns on the headlight. The ECU 316 receives the upper illuminance and forward illuminance detected by the illuminance sensors 318 from the illuminance sensors 318 as illuminance signals 322, and controls the light amounts of the lights 317 using control signals 321. Also, the ECU 316 includes the illuminance signals 322 from the illuminance sensors 318 in a signal 320, and transmits the signal 320 to the controller 200. The controller 200 recognizes the upper illuminance detected by the upper illuminance sensor 405 and the forward illuminance detected by the forward illuminance sensor 406 based on the signal 320, and transmits the recognized illuminance to the CMS-ECU 300 as the forward illuminance signal 305 and the upper illuminance signal 306.

The controller 200 performs various types of control on the ECU 316 using a control signal 319. For example, when an ON/OFF setting or the like of the automatic lighting function is received from the driver via the display device 216, the controller 200 controls the ECU 316 using the control signal 319. Also, when the automatic lighting function is OFF, the controller 200 can also instruct the control amounts of light amounts of the lights 317 to the ECU 316 using the control signal 319.

Here, the brightness control of the CMS displays 301 and 302 in the present embodiment will be described. The CMS 330 has already been started in a stage in which, after a driver has gotten into the vehicle 1, started the engine, and operated a start switch, the driver starts the traveling of the vehicle 1. With such a configuration, the visibility of left-rearward and right-rearward views can be secured when the vehicle 1 starts traveling. However, the brightness control of the CMS displays 301 and 302 in accordance with the peripheral illuminance of the vehicle 1 is performed after the engine has been started or after the start switch has been operated, and therefore the brightness of the CMS displays 301 and 302 may not be in accordance with the peripheral illuminance at a point in time immediately after the start of traveling.

Therefore, in the present embodiment, the brightness control of the CMS displays 301 and 302 in accordance with the peripheral illuminance of the vehicle 1 is performed even at a timing before, after the engine has been started or after the start switch has been operated, traveling of the vehicle 1 is started. With such a configuration, the CMS displays 301 and 302 can be set to a brightness in accordance with the peripheral illuminance of the vehicle 1 already at a point in time immediately after starting the traveling of the vehicle 1, and the left-rearward and right-rearward visibility of the driver can be improved.

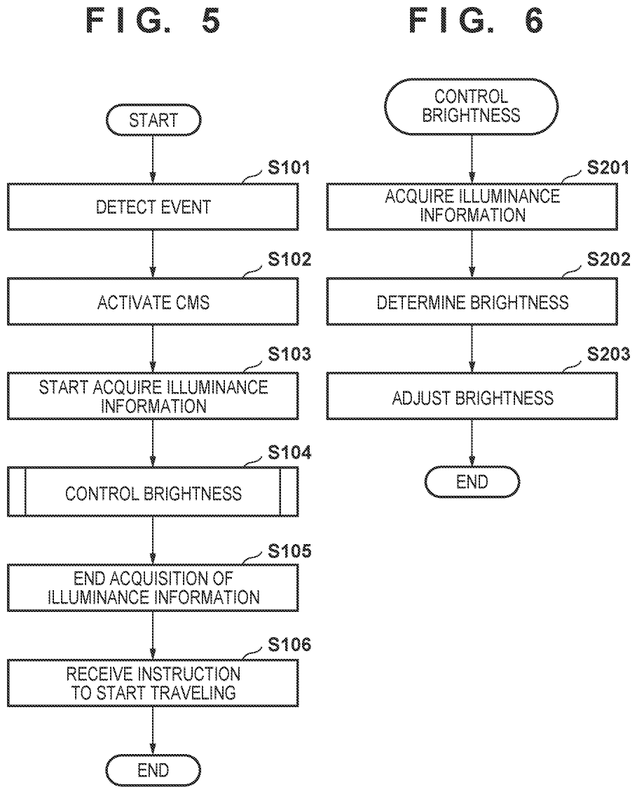

FIG. 5 is a flowchart illustrating processing for controlling the brightness of the CMS displays 301 and 302 in the present embodiment. The processing in FIG. 5 is realized by at least one of the controller 200 and the CMS-ECU 300 reading out a program stored in a storage region such as a ROM, and executing the program, for example.

In step S101, the controller 200 detects an event that has occurred in the vehicle 1. Here, the event refers to an event that may occur accompanying a motion of the driver for getting into the vehicle 1, and is an opening operation based on releasing a doorlock or a latch, or a closing operation after an opening operation of the door, for example. The controller 200 acquires such events via an ECU that is installed at a door part.

In step S102, the CMS 330 is activated, triggered by the event detection in step S101. This activation may be performed by the controller 200, or may be performed by a power controller (not illustrated) that controls activation of the ECUs in FIG. 1, for example. Note that, in step S102, the automated lighting system 331 has also already been activated, triggered by the event detection in step S101. Therefore, the controller 200 can receive illuminance information from the illuminance sensors 318 by the signal 320. However, at this point in time, the controller 200, even if illuminance information generated by the illuminance sensors 318 has been received from the ECU 316, does not transmit the illuminance information to the CMS-ECU 300 by the forward illuminance signal 305 and the upper illuminance signal 306.

In step S103, the CMS-ECU 300 starts acquiring illuminance information detected by the illuminance sensors 318. Here, the illuminance signal from the controller 200 may be transmitted a plurality of times at predetermined time intervals. Also, in step S103, the controller 200 transmits a brightness step value designated by the driver through the display device 216 to the CMS-ECU 300 using the brightness step value signal 307. Alternatively, the controller 200 may transmit a predetermined brightness step value that is determined as a default to the CMS-ECU 300, instead of the brightness step value designated by the driver through the display device 216.

Alternatively, the controller 200 may transmit, to the CMS-ECU 300, a brightness step value that has been acquired through designation by the driver, for example, in the former traveling.

FIG. 10 is a flowchart illustrating processing for retaining the brightness step value at the end of previous traveling performed before the processing in FIG. 5 is executed. The processing in FIG. 10 is realized by the controller 200 reading out a program stored in a storage region such as a ROM, and executing the program, for example. In step S501, upon receiving a traveling end instruction such as stopping the engine (ignition off), in step S502, the controller 200 stores the brightness step value designated by the driver at this point in time to a storage region. Thereafter, the processing in FIG. 10 is ended. In step S103, the controller 200 may transmit the brightness step value stored in the storage region, as described above, to the CMS-ECU 300.

In step S104, the CMS-ECU 300 controls the brightness of the CMS displays 301 and 302 based on the forward illuminance signal 305, the upper illuminance signal 306, and the brightness step value signal 307. The brightness control in step S104 will be described later. Note that, in step S104, the controller 200 may display a message such as “Brightness of CMS display is under control” or the like on the display device 216.

In step S105, the CMS-ECU 300 ends acquisition of the illuminance information detected by the illuminance sensors 318. For example, upon receiving notification that the brightness control is ended from the CMS-ECU 300, the controller 200 stops execution of transmitting the illuminance information to the CMS-ECU 300 using the forward illuminance signal 305 and the upper illuminance signal 306. Also, in the processing in FIG. 5, the processing in step S106 may be performed after the processing in step S104, without performing the processing in step S105.

In step S106, the controller 200 receives instruction to start the traveling of the vehicle 1 when the engine is started (ignition on) or when an operation is performed on a start switch. In step S106, the controller 200 may display a message such as “Brightness control of CMS display is ended” on the display device 216. According to such a configuration, after the brightness control of CMS displays 301 and 302 is ended, the driver can reliably instruct to start the traveling of the vehicle 1 after having started the engine or operated the start switch. After step S106, the processing in FIG. 5 is ended. Also, in the processing in FIG. 5, the processing in step S106 need not be performed. The configuration may be such that the instruction to start the traveling of the vehicle 1 can be accepted while the brightness control is being performed. The light 317 is controlled based on the illuminance detected by the illuminance sensors 318 after the processing in FIG. 5.

FIG. 6 is a flowchart illustrating the processing for brightness control in step S104. In step S201, the CMS-ECU 300 acquires illuminance information for determining the brightness of the CMS displays 301 and 302 based on the illuminance information received from the controller 200 through the forward illuminance signal 305 and the upper illuminance signal 306. For example, the CMS-ECU 300 may adopt one of the forward illuminance signal 305 and the upper illuminance signal 306 that indicates higher illuminance. Also, the CMS-ECU 300 may acquire a median value or an average value of the illuminance based on a plurality of pieces of illuminance information that have been received a plurality of times from the controller 200 through the forward illuminance signal 305 and the upper illuminance signal 306, as the illuminance information for determining the brightness, for example.

In step S202, the CMS-ECU 300 determines the brightness of the CMS displays 301 and 302 based on the illuminance information acquired in step S201. First, the CMS-ECU 300 specifies the correspondence relation identified by the brightness step value received from the controller 200 using the brightness step value signal 307, from the plurality of types of correspondence relations between the peripheral illuminance and the brightness in FIG. 8. Also, the CMS-ECU 300 determines the brightness corresponding to the illuminance acquired in step S201 on the specified correspondence relation, as the target brightness.

In step S203, the CMS-ECU 300 adjusts the brightness of the CMS displays 301 and 302 from the current brightness to the target brightness determined in step S202. The CMS-ECU 300 transmits the target brightness determined in step S202 to the CMS displays 301 and 302 using the brightness signals 309 and 312. Also, the CMS-ECU 300 transmits, to the CMS displays 301 and 302, information regarding the gradual change period determined based on the difference between the current brightness and the target brightness using the gradual change period information 310 and 313. The CMS-ECU 300 adjusts the brightness of the CMS displays 301 and 302 based on the brightness signals 309 and 312 and the gradual change period information 310 and 313. After step S203, the processing in FIG. 6 is ended. Also, the CMS-ECU 300 need not use the gradual change period information 310 and 313 when adjusting the brightness of the CMS displays 301 and 302.

As described above, according to the present embodiment, the brightness of the CMS displays 301 and 302 can already be adjusted in accordance with the peripheral illuminance of the vehicle 1 immediately after starting traveling of the vehicle 1, and the left-rearward and right-rearward visibility of the driver can be improved.

In the above description, it is assumed that the controller 200 can receive the illuminance signal from the illuminance sensors 318 through the signal 320 already at the point in time when the processing in step S102 is performed. However, there are cases where the automated lighting system 331 has not been activated in step S102. For example, such cases include a case where the ECU 316 is constituted by a sub ECU that controls the light 317, and a sub ECU that controls the illuminance sensors 318, and the sub ECU that controls the illuminance sensors 318 has not been activated. In this case, the configuration may be such that, in step S103, the controller 200 or an unshown power controller activates the sub ECU that controls the illuminance sensors 318, the controller 200 receives the illuminance signal of the illuminance sensors 318 through the signal 320, and the illuminance signal is transmitted to the CMS-ECU 300 using the forward illuminance signal 305 and the upper illuminance signal 306. Also, the configuration may be such that, in step S105, the controller 200 or the unshown power controller stops supplying power to the sub ECU that controls the illuminance sensors 318. With such a configuration, power consumption can be kept at a low level until the peripheral illuminance of the vehicle 1 changes.

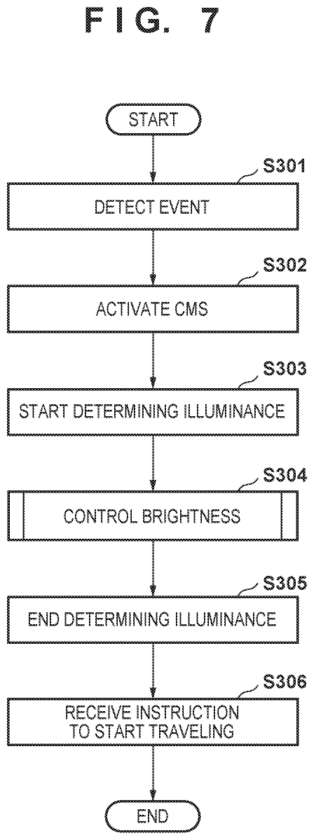

FIG. 7 is another flowchart illustrating processing for controlling the brightness of the CMS displays 301 and 302. The processing in FIG. 7 is different from the processing in FIG. 5 with respect to steps S303 and S305. Steps S301, S302, S304, and S306 are the same as steps S101, S102, S104, and S106 in FIG. 5, and therefore the description thereof will be omitted.

In step S303, the controller 200 acquires environmental information along with acquiring the illuminance signal of the illuminance sensors 318, and determines the peripheral illuminance of the vehicle 1 based on the acquired environmental information. Here, the environmental information is time information and weather information regarding such as temperature and humidity, for example.

For example, when the driver has started the engine in an indoor parking space, it is conceivable that the illuminance detected by the illuminance sensors 318 is relatively low, even in the daytime. Therefore, in step S303, the controller 200 determines the reliability of the illuminance detected by the illuminance sensors 318 based on the environmental information. For example, if the controller 200 recognizes that it is daytime from the time information, and the weather is fine from the weather information, and the illuminance detected by the illuminance sensors 318 is not in a predetermined illuminance range (predetermined illuminance or less), the controller 200 does not adopt the illuminance detected by the illuminance sensors 318, and adopts illuminance determined based on the time information and the weather condition. The controller 200 transmits the adopted illuminance information to the CMS-ECU 300 using the forward illuminance signal 305 and the upper illuminance signal 306 after the CMS 330 is activated. In this case, the forward illuminance signal 305 and the upper illuminance signal 306 may be transmitted as signals indicating the same illuminance.

When the brightness control is ended in step S304, in step S305, the controller 200 ends determining the peripheral illuminance of the vehicle 1 based on the environmental information.

As described above, according to the processing in FIG. 7, the reliability of the illuminance detected by the illuminance sensors 318 is determined, and the illuminance is determined, as needed, based on the environmental information. With such a configuration, the illuminance can be appropriately determined depending on the situation. Also, in FIG. 7, determining the reliability of the illuminance detected by the illuminance sensors 318 is described, but such determination need not be performed. For example, the controller 200 may estimate the illuminance directly from the environmental information such as time information and weather condition without using the detection signal of the illuminance sensors 318.

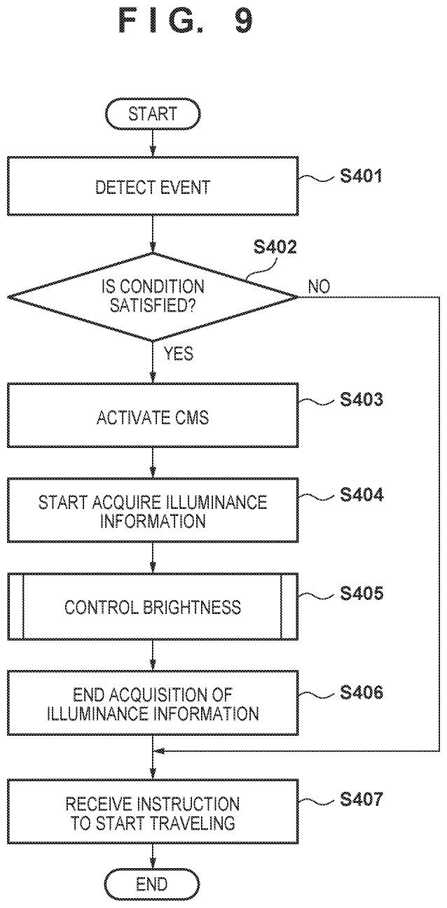

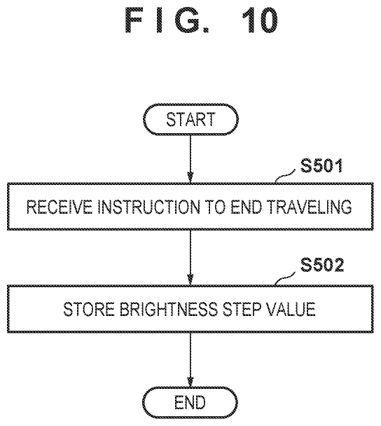

FIG. 9 is another flowchart illustrating processing for controlling the brightness of the CMS displays 301 and 302. The processing in FIG. 9 is different from the processing in FIG. 5 with respect to step S402. Steps S401, and S403 to S407 are the same as steps S101, and S102 to S106 in FIG. 5, and therefore the description thereof will be omitted.

Upon detecting an event that has occurred in the vehicle 1 in step S401, the controller 200 determines, in step S402, whether or not the event detection satisfies a condition. For example, when the controller 200 has detected a closing operation of a door after an opening operation thereof, if the situation inside the vehicle 1 has changed from a situation in which a driver is not present to a situation in which a driver is present, the controller 200 determines that the condition is satisfied, and advances the processing to step S403. On the other hand, if the controller 200 detects that the situation inside the vehicle 1 has not changed from the situation in which a driver is present, the controller 200 determines that the condition is not satisfied, and advances the processing to step S407. Whether or not a driver is present is detected using the interior recognition camera 209 and the interior recognition sensor 210, for example.

That is, when a driver temporarily stops the car at a free space such as that of a road shoulder or the like, and takes a short rest, it is conceivable that the brightness of the CMS displays 301 and 302 has already been adjusted. In this case, even if the opening/closing of a door has been performed, the processing from step S403 to step S406 need not be performed. As shown in FIG. 9, as a result of performing determination as to whether or not the condition is satisfied in step S402, the processing until receiving an instruction to start traveling can be efficiently executed.

### Summary of Embodiment

A vehicle control apparatus of the embodiment described above includes: a shooting unit (CMS camera 303, 304) configured to shoot a periphery of a vehicle; a display unit (CMS display 301, 302) configured to display an image shot by the shooting unit; an acquisition unit (CMS-ECU 300) configured to acquire illuminance information regarding peripheral illuminance of the vehicle; and a control unit (CMS-ECU 300) configured to control a display mode of the display unit based on the illuminance information acquired by the acquisition unit. At a predetermined timing pertaining to reception of an instruction relating to traveling of the vehicle, the acquisition unit starts acquiring the illuminance information (S103), when the display unit starts displaying the image. The predetermined timing is before receiving an instruction to start traveling of the vehicle.

With such a configuration, the display of the CMS displays can be controlled in accordance with the peripheral illuminance before receiving an instruction to start traveling of the vehicle, for example.

Also, the shooting unit, the display unit, the acquisition unit, and the control unit constitute a peripheral monitoring system (CMS 330) that monitors the periphery of the vehicle. Also, the vehicle control apparatus further includes a detection unit (illuminance sensors 318) that is installed in a system (automated lighting system 331) that is different from the peripheral monitoring system, and is configured to detect the peripheral illuminance of the vehicle.

With such a configuration, the illuminance detected by the illuminance sensor of the automated lighting system can be used to control the display of the CMS display, for example.

Also, the acquisition unit starts acquiring the illuminance information, by a system different from the peripheral monitoring system being activated. Also, the system different from the peripheral monitoring system stops when the acquisition unit ends acquiring the illuminance information.

With such a configuration, a configuration can be realized in which the illuminance information is acquired by activating an ECU of the automated lighting system, for example. Also, the ECU is stopped when the acquisition of the illuminance information is ended, and as a result, power consumption can be reduced.

Also, the acquisition unit starts acquiring the illuminance information in response to an event that has occurred in the vehicle (S101). Also, the event is any of releasing a doorlock, an opening operation of a door, and a closing operation of a door after the door has been opened.

With such a configuration, acquisition of the illuminance information can be started in response to an opening operation of a door, for example.

Also, the acquisition unit starts acquiring the illuminance information when the occurrence of the event satisfies a condition (S402). Also, the condition is that a passenger is not present in the vehicle before the occurrence of the event, and a passenger is present in the vehicle after the occurrence of the event.

With such a configuration, when a passenger is getting into the vehicle, the control of the CMS display in accordance with the illuminance information can be executed, for example.

Also, the acquisition unit acquires the illuminance information using environmental information (S303). Also, the environmental information includes any of time information and weather information.

With such a configuration, the illuminance information can be estimated using the time information.

The present invention is not limited to the embodiment described above, and various modifications and changes are possible within the scope of the invention.

What is claimed is:

1. A vehicle control apparatus comprising:
a shooting unit configured to shoot a periphery of a vehicle;
a display unit configured to display an image shot by the shooting unit;
an acquisition unit configured to acquire illuminance information regarding peripheral illuminance of the vehicle; and
a control unit configured to control a display mode of the display unit based on the illuminance information acquired by the acquisition unit,
wherein, at a predetermined timing pertaining to reception of an instruction relating to traveling of the vehicle, the acquisition unit starts acquiring the illuminance information, when the display unit starts displaying the image.

2. The vehicle control apparatus according to claim 1, wherein the predetermined timing is before receiving an instruction to start the traveling of the vehicle.

3. The vehicle control apparatus according to claim 1, wherein the shooting unit, the display unit, the acquisition unit, and the control unit constitute a peripheral monitoring system that monitors the periphery of the vehicle.

4. The vehicle control apparatus according to claim 3, further comprising a detection unit that is installed in a system that is different to the peripheral monitoring system, and is configured to detect the peripheral illuminance of the vehicle.

5. The vehicle control apparatus according to claim 4, wherein the acquisition unit starts acquiring the illuminance information by a system different from the peripheral monitoring system being activated.

6. The vehicle control apparatus according to claim 4, wherein the system different to the peripheral monitoring system stops when the acquisition unit ends acquiring the illuminance information.

7. The vehicle control apparatus according to claim 1, wherein the acquisition unit starts acquiring the illuminance information in response to an event that has occurred in the vehicle.

8. The vehicle control apparatus according to claim 7, wherein the event is any of releasing a doorlock, an opening operation of a door, and a closing operation of a door after the door has been opened.

9. The vehicle control apparatus according to claim 7, wherein the acquisition unit starts acquiring the illuminance information when the event that has occurred in the vehicle satisfies a condition.

10. The vehicle control apparatus according to claim 9, wherein the condition is that a passenger is not present in the vehicle before the occurrence of the event, and a passenger is present in the vehicle after the occurrence of the event.

11. The vehicle control apparatus according to claim 1, wherein the acquisition unit acquires the illuminance information using environmental information.

12. The vehicle control apparatus according to claim 11, wherein the environmental information includes any of time information and weather information.

13. A control method to be executed in a vehicle control apparatus, the control method comprising:
displaying an image shot by a shooting unit that shoots a periphery of a vehicle;
acquiring illuminance information regarding peripheral illuminance of the vehicle;
controlling a display mode of the display unit based on the acquired illuminance information; and
at a predetermined timing pertaining to reception of an instruction relating to traveling of the vehicle, starting acquiring the illuminance information, when the display unit starts displaying the image.

14. A non-transitory computer-readable storage medium storing a program causing a computer to:
display an image shot by a shooting unit that shoots a periphery of a vehicle;
acquire illuminance information regarding peripheral illuminance of the vehicle;
control a display mode of the display unit based on the acquired illuminance information; and
at a predetermined timing pertaining to reception of an instruction relating to traveling of the vehicle, start acquiring the illuminance information, when the display unit starts displaying the image.
